(19) United States
(12) Patent Application Publication
(10) Pub. No.: US 2020/0038906 A1
(43) Pub. Date: Feb. 6, 2020

(54) Polymer-Collagen Composite Film And Method Of Forming The Same

(71) Applicant: Tair Jiuh Enterprise, Tainan City (TW)

(72) Inventors: Po-Han Chen, Tainan City (TW); I-Ming Chen, Tainan City (TW); Tung-Liang Chen, Tainan City (TW)

(21) Appl. No.: 16/452,826

(22) Filed: Jun. 26, 2019

(30) Foreign Application Priority Data
Aug. 1, 2018 (CN) 201810862174.7

(51) Int. Cl. B05D 7/04; B05D 3/14

(52) U.S. Cl. CPC B05D 7/04; B05D 3/144

(57) ABSTRACT

The present invention provides a polymer-collagen composite film and a method of forming the same. In the method, a surface of a polymer substrate is treated by plasma, and collagen is then grafted to the surface, thereby forming the polymer-collagen composite film. The composite film has good hydrophilicity and biocompatibility.

### CROSS-REFERENCE TO RELATED APPLICATION

This application claims priority to China Application Serial Number 201810862174.7, filed Aug. 1, 2018, which is herein incorporated by reference in its entirety.

### BACKGROUND

### Field of Invention

The present invention relates to a composite film and a method of forming the same. More particularly, the present invention relates to a method including performing a plasma treatment on a surface of a polymer substrate, and grafting collagen to the surface after the plasma treatment, thereby forming a polymer-collagen composite film having good hydrophilicity.

### Description of Related Art

Polymer substrates are widely used in cosmetic and medical fields, for example, the polymer substrates are used as dressings, a support layer of the dressings, a substrate of a facial mask, and the like. To further improve the applicability or bio-compatibility of the polymer substrates in these fields, a variety of modifications are typically performed to modify the polymer substrates.

For instance, collagen is widely used in various medical materials because the collagen is able to cure damaged tissues and retain moisture. However, the collagen has problems such as insufficient supporting capacity and mechanical strength, such that the fields to which the collagen is applicable are very limited. Therefore, the polymer substrate can be used as a bottom layer to improve the insufficient strength of the collagen. Further modification may be performed on the polymer substrate to form a composite film having sufficient strength and merits of the collagen. A common method may be, for example, mixing a material of the polymer substrate and the collagen, such that the material of the polymer substrate and the collagen collectively form a film; forming a collagen layer on the surface of the polymer substrate by a chemical cross-linking method; or, fixing the collagen layer on the surface of the polymer substrate by an adhesive layer. Nevertheless, a great amount of the collagen is wasted, and the modifying efficiency is not satisfactory in these methods.

A known method is to perform a plasma treatment on the surface of the polymer substrate, and make the collagen in contact with the treated surface, so as to graft the collagen to the polymer substrate. However, a low power is used in the method, and a large area of the surface of the substrate is treated at the same time, causing a longer treating time and unsatisfactory efficiency.

Therefore, a method of forming a polymer-collagen composite film is required, in which a satisfactory efficiency for grafting the collagen to the polymer substrate is achieved, and the process time can be shortened. In addition, the polymer-collagen composite film can have good hydrophilicity and bio-compatibility.

### SUMMARY

An aspect of the present invention provides a method of forming a polymer-collagen composite film. The method includes performing a plasma treatment on a polymer substrate, and grafting collagen to the polymer substrate, so as to form the composite film. The method can effectively increase the amount of the collagen grafted to the polymer substrate.

According to the aspect of the present invention, a method of forming a polymer-collagen composite film is provided. In some embodiments, the method includes the following steps. First, a polymer substrate is provided. Next, a plasma treatment is performed on a surface of the polymer substrate, so as to form a treated film. The plasma treatment is performed on different locations of the surface at a moving rate during a treatment time period. Then, collagen is made to contact the treated film, thereby forming a polymer-collagen composite film.

In accordance with some embodiments of the present invention, the treatment time period is in a range from 1 second to 10 seconds.

In accordance with some embodiments of the present invention, a power of the plasma treatment is in a range from 400 W to 800 W.

In accordance with some embodiments of the present invention, the moving rate is in a range from 200 mm/sec to 400 mm/sec.

In accordance with some embodiments of the present invention, a height for performing the plasma treatment is in a range from 5 mm to 10 mm.

In accordance with some embodiments of the present invention, a material of the polymer substrate includes polyurethane, polyethylene, polysiloxane or chitosan.

In accordance with some embodiments of the present invention, the polymer substrate includes a polymer film or a polymer powder.

In accordance with some embodiments of the present invention, making the collagen in contact with the treated film includes coating a collagen solution onto a surface of the treated film.

In accordance with some embodiments of the present invention, making the collagen in contact with the treated film includes forming a bond between the treated film and the collagen.

In accordance with some embodiments of the present invention, making the collagen in contact with the treated film is performed for 1 hour to 12 hours.

The other aspect of the present invention provides a polymer-collagen composite film which is formed by the method described above. In some embodiments, the polymer-collagen composite film includes a polymer layer and a collagen layer bonding to a surface of the polymer layer. The polymer-collagen composite film has satisfactory hydrophilicity and bio-compatibility.

Compared to the typical methods, advantages of the present invention may have the following merits. By performing the plasma treatment with certain process parameters, the method of forming the polymer-collagen composite film can significantly increase the amount of the collagen grafted to the polymer substrate, leading to improvement in the hydrophilicity of the polymer-collagen composite film. In addition, the method can also shorten the process time, and the polymer-collagen composite film has satisfactory bio-compatibility and can be applied to the wound dressing.

### BRIEF DESCRIPTION OF THE DRAWINGS

The invention can be more fully understood by reading the following detailed description of the embodiment, with reference made to the accompanying drawings as follows:

FIG. 1 is a flow chart showing a method of forming a polymer-collagen composite film in accordance with some embodiments of the present invention.

FIG. 2A and FIG. 2F are schematic cross-sectional views showing intermediate stages of forming a polymer-collagen composite film in accordance with some embodiments of the present invention.

FIG. 2B through FIG. 2E are schematic top views showing different embodiments of a plasma treatment.

FIG. 3A and FIG. 4A are dyeing results of Comassie blue.

FIG. 3B and FIG. 4B are dyeing results of Genipin.

FIG. 5 through FIG. 10 are three dimensional (3D) diagrams of an atomic force microscopy (AFM).

FIG. 11 is a bar chart of a cell adhesion experiment.

FIG. 12 is a bar chart of a cell cytotoxicity experiment.

### DETAILED DESCRIPTION

An aspect of the present invention provides a method of forming a polymer-collagen composite film. In the method, a surface of a polymer substrate is activated using a plasma treatment, such that collagen contacting the surface is able to be grafted (or bond) to the surface. Specifically, the plasma treatment may produce radicals or peroxide groups having high reactivity on the surface. Therefore, when the collagen contacts these radicals or the peroxide groups, the collagen reacts with the surface to form a covalent bond. In some embodiments, the formed covalent bond includes but is not limited to a carbon-oxygen bond or a carbon-nitrogen bond.

Particularly, the plasma treatment with a variable treatment location (i.e. the location where the plasma treatment is performed is not fixed) is provided in the present invention. During a certain treatment time period, plasma having a high power and specific moving rate is used in the plasma treatment, so as to effectively activate the surface of the polymer substrate and increase an amount of the collagen grafted to the surface. In addition, the method is advantageous to shorten a process time, and it also avoids damages on the polymer substrate caused by the plasma treatment repeatedly performed at the same location for a long time.

The term of “variable treatment location” indicates that a nozzle for applying the plasma can move during the plasma treatment, so as to perform the plasma treatment onto different locations of the polymer substrate. Alternatively, the nozzle for applying the plasma can be fixed while the polymer substrate is movable.

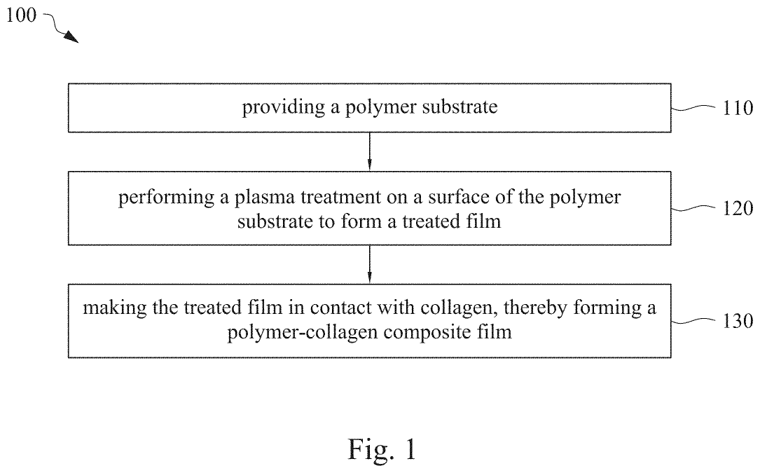

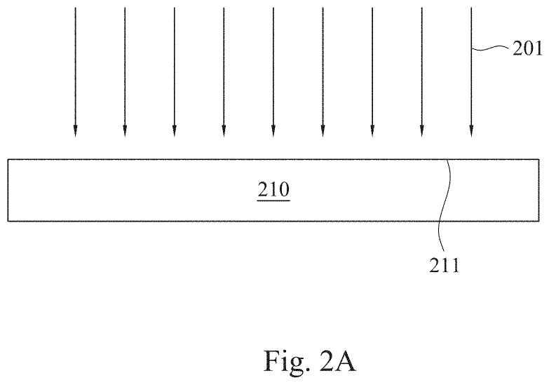

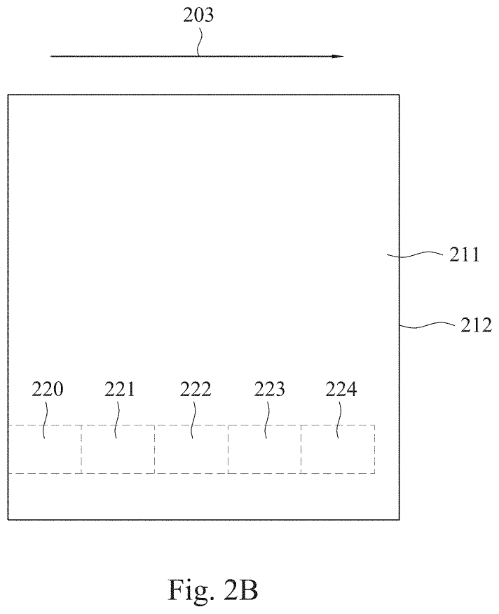

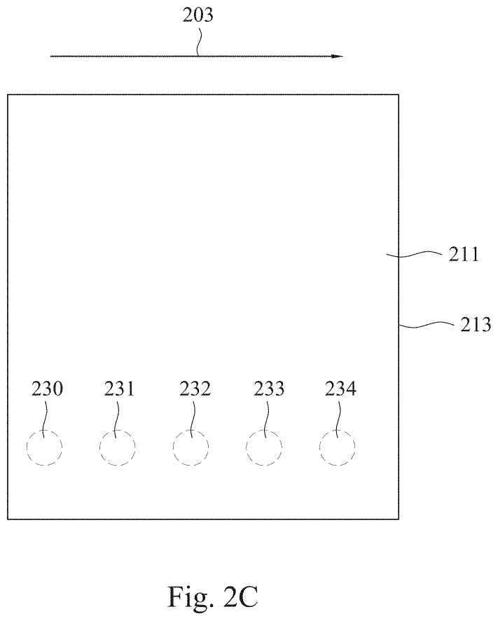

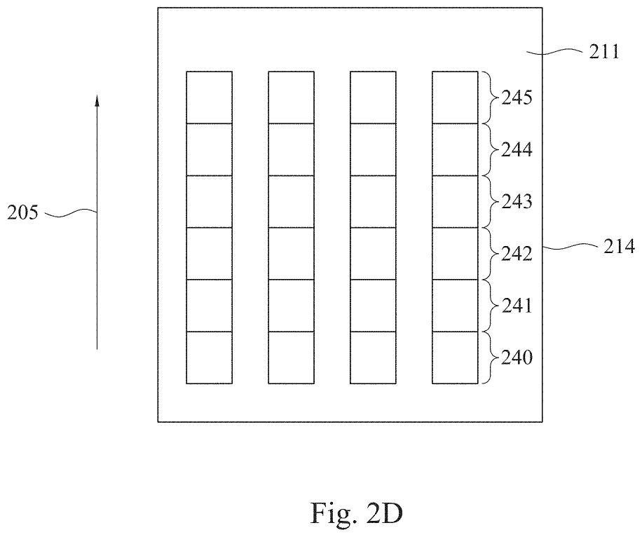

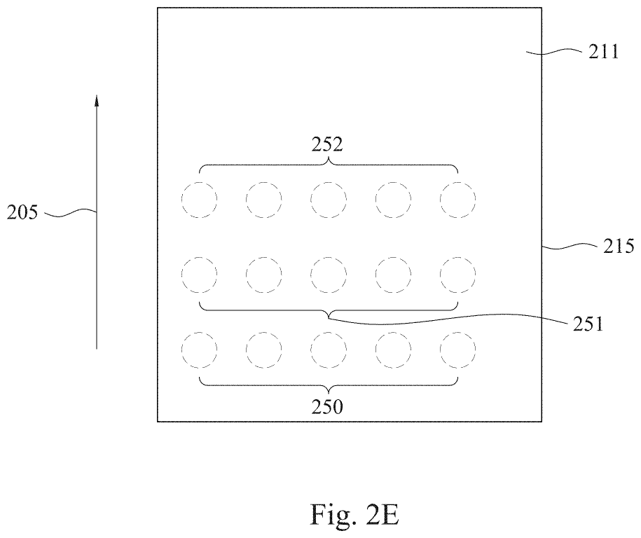

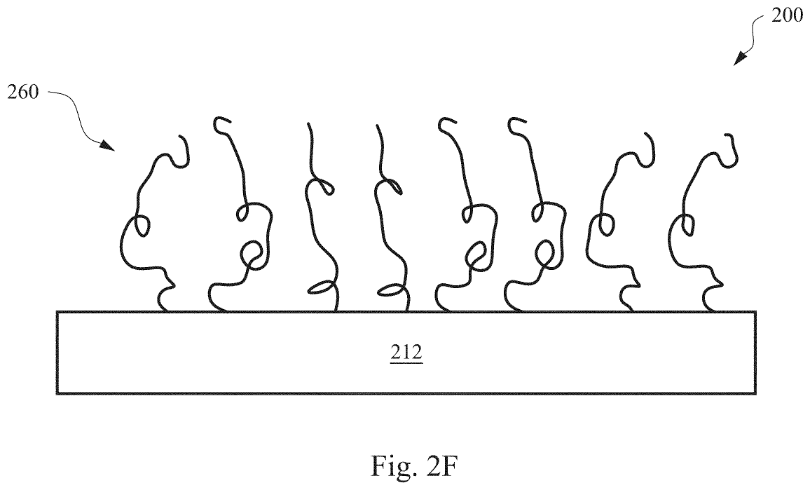

The method of forming the polymer-collagen composite film is described with reference to FIG. 1 and FIG. 2A to FIG. 2F. FIG. 1 is a flow chart showing a method of forming a polymer-collagen composite film in accordance with some embodiments of the present invention. FIG. 2A and FIG. 2F are schematic cross-sectional views showing intermediate stages of forming a polymer-collagen composite film in accordance with some embodiments of the present invention. FIG. 2B through FIG. 2E are schematic top views showing different embodiments of a plasma treatment.

In a method 100, as shown in step 110, a polymer substrate 210 is provided. In some embodiments, a material of the polymer substrate 210 may include polyurethane, polyethylene, polysiloxane or chitosan. In some embodiments, the polymer substrate 210 can include a polymer film or a polymer powder. In some examples, the polymer film may be formed by any common method of film formation using the material described above. For example, the polymer film is formed by coating the polymer material onto a surface of a substrate and drying the polymer material. Alternatively, the polymer film is formed by filling the polymer material into a mold. In some examples, the polymer film may have a porous sponge structure which can be formed by a typical foam molding process. In some examples, the polymer powder can be formed by any common method of powder formation using the material described above. For example, the polymer powder is formed by curing the polymer material, followed by crushing and grinding the cured polymer material.

Next, in step 120, a plasma treatment 201 is performed to a surface 211 of the polymer substrate 210, as shown in FIG. 2A. The plasma treatment 201 is performed on different locations of the surface 211 at a moving rate during a treatment time period, and the plasma treatment 201 may be performed by using embodiments shown in FIG. 2B, FIG. 2C, FIG. 2D or FIG. 2E. The embodiments are respectively described as follows.

In the embodiment of FIG. 2B, merely a nozzle (not shown) is used for applying the plasma. In this example, the plasma treatment 201 is a continuous plasma treatment; that is, the plasma is continuously provided from the nozzle during the plasma treatment. Therefore, when the nozzle moves along, for example, a direction 203, the plasma treatment 201 is performed on locations 220, 221, 222, 223 and 224 of the surface 211 in sequence, thereby forming a treated film 212.

Alternatively, in the embodiment of FIG. 2C, merely a nozzle (not shown) is used. The difference is that the plasma treatment 201 is an interrupted plasma treatment in this example; that is, the plasma is interruptedly provided from the nozzle during the plasma treatment. For example, the plasma is applied and the plasma treatment 201 is performed on a location 230 at a first time. Then, the operation of applying the plasma is stopped and the nozzle moves to a location 231 along a direction 203. Next, the plasma is applied and the plasma treatment 201 is performed on the location 231 at a second time. Thereafter, the operations are repeated in sequence, thereby forming a treated film 213.

Alternatively, in the embodiment of FIG. 2D, several nozzles (not shown) for applying the plasma are used. For example, four nozzles may be arranged in a row. In this example, similar to FIG. 2B, the continuous plasma treatment 201 is performed. Therefore, when the nozzles move along, for example, a direction 205, the plasma treatment 201 may be performed on rows 241, 242, 243, 244 and 245 of the surface 211 in sequence, so as to form a treated film 214.

Alternatively, in the embodiment of FIG. 2E, several nozzles (not shown) for applying the plasma are used. For example, four nozzles may be arranged in a row. In this example, similar to FIG. 2C, the interrupted plasma treatment 201 is performed. For example, the plasma is applied and the plasma treatment 201 is performed on a row 250 at the first time. Then, the operation of applying the plasma is stopped and the nozzles move to a row 251 along the direction 205. Next, the plasma is applied and the plasma treatment 201 is performed on a row 251 at the second time. The operations are repeated in sequence, so as to form a treated film 215.

Specific numbers of the treated locations (e.g., the locations 220 to 224, 230 to 234, and the rows 240 to 245 and 250 to 252) are shown in FIG. 2B, FIG. 2C, FIG. 2D and FIG. 2E for simplification of the illustrations; however, the plasma treatments of FIG. 2B, FIG. 2C, FIG. 2D and FIG. 2E may be respectively performed on the entire surface 211 of the polymer substrate 210. In addition, when the polymer powder is used as the polymer substrate 210, the polymer powder may be uniformly dispersed, and the plasma treatments shown in FIG. 2B, FIG. 2C, FIG. 2D and FIG. 2E may be performed, though FIG. 2B, FIG. 2C, FIG. 2D and FIG. 2E merely show the embodiments where the polymer substrate 210 is the polymer film.

In some embodiments, the moving rate of the nozzle(s) is in a range from 200 mm/sec to 400 mm/sec. When the moving rate is smaller than 200 mm/sec, too much energy will be applied onto the surface 211 of the polymer substrate 210, leading to damages of a structure of the polymer substrate 210. When the moving rate is greater than 400 mm/sec, the activation of the polymer substrate is incomplete, causing insufficient efficiency of grafting the collagen to the polymer substrate 210.

In some embodiments, a height for performing the plasma treatment 201 is in a range from 5 mm to 10 mm. The height may be regarded as a distance between the nozzle and the surface 211 of the polymer substrate 210. When the height is smaller than 5 mm, too much energy will be applied onto the surface 211 of the polymer substrate 210, leading to damages of the structure of the polymer substrate 210. When the height is greater than 10 mm, the efficiency of the plasma treatment 201 is insufficient.

In some embodiments, a power of the plasma treatment 201 is in a range from 400 W to 800 W. When the power is smaller than 400 W, the efficiency of the plasma treatment 201 is insufficient. When the power is greater than 800 W, too much energy will be applied onto the surface 211 of the polymer substrate 210, leading to damages of the structure of the polymer substrate 210.

In some embodiments, to a polymer substrate 210 having an area of 20 cm² to 200 cm², the plasma treatment 201 may be performed for a total time (i.e., the treatment time period) of 1 second to 10 seconds. When the treatment time period lasts for too long, temperature may increase, leading to melt or damages of the polymer substrate 210.

In some embodiments, the plasma treatment 201 may be performed by using, for example, atmospheric-pressure plasma such as low current plasma jet, dielectric barrier discharge, corona discharge or high temperature plasma torch. In some examples, the plasma treatment 201 may be performed using oxygen gas, nitrogen gas or argon gas, while the plasma treatment of the present invention is not limited to these examples.

It is noted that when the plasma treatment is not performed on different locations at different times but is performed on the entire surface of the polymer substrate simultaneously, the high power may cause high temperature, leading to the damages on the structure of the polymer substrate. In addition, to perform the plasma treatment on the entire surface at the same time, an apparatus having a high standard may be required, leading to greater manufacturing costs.

Please refer to FIG. 1 again. In step 130, the treated film (e.g., the treated film 212, but it can also be the treated films 213, 214 or 215) is made to contact collagen 260, so as to form a polymer-collagen composite film 200, as shown in FIG. 2F.

In some embodiments, the step 130 can be performed by coating a collagen solution onto the surface 211 of the treated film 212, such that the treated film 212 contacts the collagen 260. A bond is formed between the treated film 212 and the collagen 260 by groups having high reactivity such as radicals on the treated film 212. In one example, the collagen 260 may be collagen triple helix having a weight average molecular weight of 30,000 to 300,000. The collagen triple helix may be type I collagen. The pH of the collagen solution may be in a range from pH 2 to pH 5. In other embodiments, the step 130 is performed by, for example, immersing the treated film 212 into the collagen solution.

In some embodiments, the treated film 212 is made to contact the collagen 260 for 1 hour to 12 hours. When the contacting time is less than 1 hour, the amount of the collagen 260 grafted to the treated film 212 is insufficient. On the other hand, when the contacting time is more than 12 hours, the amount of the collagen 260 grafted to the treated film 212 will not increase more, while the time cost increases.

In some embodiments, after the step 130, the method 100 may further include washing the polymer-collagen composite film, so as to remove the collagen 260 that is not bonded to the treated film 212. In some examples, the polymer-collagen composite film may be washed by using, for example, deionized water or typical saline buffer solution.

In some embodiments, the polymer-collagen composite film may be applied to, for example, a wound dressing. The surface of the composite film having the collagen grafted thereto may contact the wound, so as to speed up wound healing. In other embodiments, the polymer-collagen composite film may be applied to a facial mask for moisture-retaining or tissue repairing.

Several examples and comparative examples are shown for describing the method of forming the polymer-collagen composite film and the advantages of the composite film.

### EXAMPLE 1

In Example 1, a circular polyurethane (PU) film having a diameter of 15 mm was provided (Pellethane 2363, manufactured by The Upjohn Company) as the polymer substrate. The plasma treatment was performed on the PU film for 0.1 minutes with the power of 600 W, the moving rate of 300 mm/sec and the height of 10 mm, so as to form the treated film (the continuous plasma treatment of FIG. 2B was used). Then, 200 μl of the collagen solution having a collagen concentration of 1 mg/ml was coated onto the treated film to perform the reaction for 1 hour, so as to obtain the polymer-collagen composite film of Example 1 having the collagen grafted thereto by the plasma treatment. Example 2 to 8 and Comparative Example 1 to 2

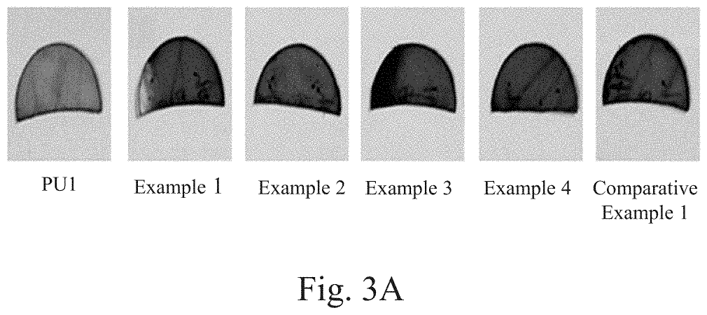

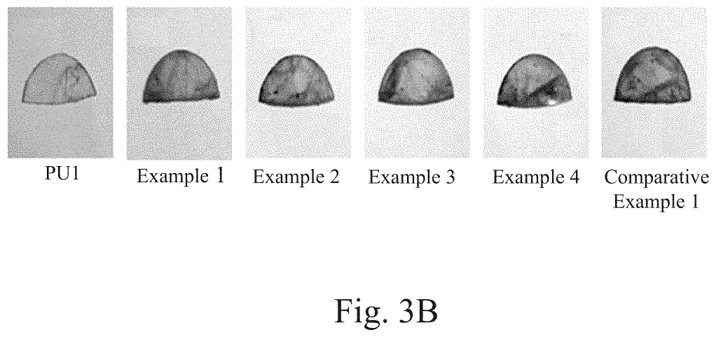

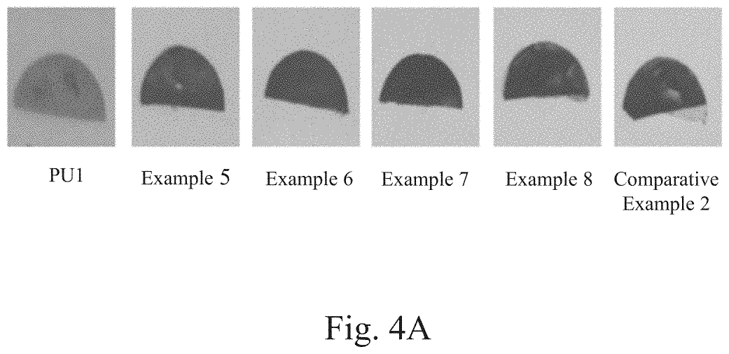

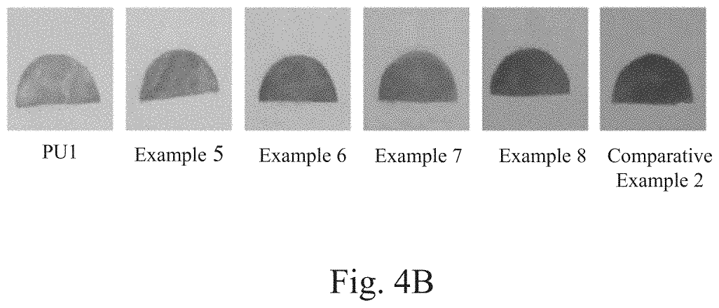

Example 2 to 8 and Comparative Example 1 to 2 were performed by the same method as Example 1. The difference was that process parameters of performing the plasma treatment or grafting the collagen to the polymer substrate were changed in Example 2 to 8 and Comparative Example 1 to 2. In addition, the operations same as those of Example 1 were performed on the PU1 of FIG. 3A and FIG. 3B, and the operations same as those of Example 5 were performed on the PU2 of FIG. 4A and FIG. 4B. However, the plasma treatment was not performed on PU1 of FIG. 3A and FIG. 3B and PU2 of FIG. 4A and FIG. 4B. The process parameter and evaluation results of Example 2 to 8 and Comparative Example 1 to 2 are shown in Table 1, FIG. 3A, FIG. 3B, FIG. 4A and FIG. 4B.

TABLE 1

| | | | | | | | | | | | Comparative | |
|---|---|---|---|---|---|---|---|---|---|---|---|---|
| | | | Example | | | | | | | | Example | |
| | | | 1 | 2 | 3 | 4 | 5 | 6 | 7 | 8 | 1 | 2 |
| Process | Polymer | | PU1 | PU1 | PU1 | PU1 | PU2 | PU2 | PU2 | PU2 | PU1 | PU2 |
| parameter | substrate | | | | | | | | | | | |
| | Power (W) | | 400 | 500 | 600 | 800 | 400 | 500 | 600 | 800 | 300 | 300 |
| | Height (mm) | | 10 | 10 | 10 | 10 | 10 | 10 | 10 | 10 | 5 | 5 |
| | Time (min) | | 0.1 | 0.1 | 0.1 | 0.1 | 0.1 | 0.1 | 0.1 | 0.1 | 1 | 1 |
| | Moving rate | | 200 | 300 | 300 | 400 | 200 | 300 | 300 | 400 | 200 | 200 |
| | (mm/sec) | | | | | | | | | | | |
| | Grafting | | 1 | 3 | 6 | 12 | 1 | 3 | 6 | 12 | 24 | 24 |
| | time (hr) | | | | | | | | | | | |
| Evaluation | contact | before | 103.67 | | | | 61.44 | | | | 103.67 | 61.44 |
| result | angle | grafting | | | | | | | | | | |
| | (degree) | grafting | 96.8 | 92.1 | 91.1 | 93.7 | 58.76 | 48.96 | 47.65 | 49.61 | 95.4 | 57.43 |
| | | without | | | | | | | | | | |
| | | performing | | | | | | | | | | |
| | | the plasma | | | | | | | | | | |
| | | treatment | | | | | | | | | | |
| | | grafting | 50.3 | 47.12 | 45.99 | 44.43 | 38.94 | 40.12 | 42.13 | 39.72 | 47.26 | 43.26 |
| | | after the | | | | | | | | | | |
| | | plasma | | | | | | | | | | |
| | | treatment | | | | | | | | | | |

PU1 Pellethane 2363(manufactured by The Upjohn Company)
PU2 Polyesterurethane 6608 (manufactured by Great Eastern Resins Industrial Co. Ltd.)

### Evaluation

### 1. Contact Angle

The evaluation of the contact angle in the present invention was performed by using an optical contact angle meter (FTA-1000 B) manufactured by First Ten Angstrom in U.S.A. A smaller contact angle indicates better hydrophilicity of the sample film. Therefore, an effect of the plasma treatment and a grafting efficiency of the collagen can be evaluated by the contact angle.

### 2. Amount of Collagen on Surface of Polymer Substrate

The evaluation of the amount of the collagen on the surface of the polymer substrate was performed by dyeing the sample film using a reagent. Comassie blue and Genipin were respectively used as dyes to estimate the amount of the collagen on the surface.

### (a) Comassie Blue

A reagent solution containing 0.5 volume percent (vt. %) Comassie blue and 5 vt. % methanol was prepared. The sample film was immersed in the reagent solution to react for 20 minutes under a room temperature (e.g, 25° C.). Then, the sample film was washed by an non-ionic surfactant (Titron, concentration: 2.5 wt. %), and then the sample film was subjected to observation. The results of Comasssie blue are shown as FIG. 3A and FIG. 4A, in which the plasma treatment was not performed on the PU1 film and the PU2 film.

### (b) Genipin

A reagent solution containing 0.5 volume percent (vt. %) Genipin and 40 vt. % ethanol is prepared. The sample film is immersed in the reagent solution to react for 24 hours to 48 hours under 37° C. Then, the sample film is washed by deionized water, and then the sample film is subjected to observation. The results of Genipin are shown as FIG. 3B and FIG. 4B, in which the plasma treatment was not performed on the PU1 film and the PU2 film.

### 3. Observation of Surface Profile

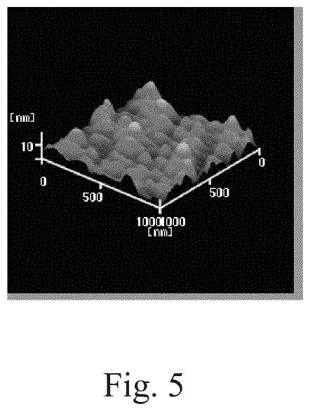

The surface profile of the examples and the comparative examples were observed using an atomic force microscopy (AFM). The results of the observation of the surface profile are shown in FIG. 5 through FIG. 10.

### 4. Cell Culture

The cell culture includes two parts, cell adhesion and cell cytotoxicity, in the examples of the present invention. The implementations of these two parts are described as follows.

In an experiment of the cell adhesion, 10⁴ of mouse L929 fibroblastic cell lines were disposed on the sample film to implement the culture of these cell lines. The cell lines were then subjected to observing the cell adhesion after the cell lines are cultured for 24 hours. In an experiment of the cell cytotoxicity, 2×10⁴ of the mouse L929 fibroblastic cell lines were disposed on the sample film to implement the culture of these cell lines. The cell cytotoxicity was then evaluated after the culture was implemented for 96 hours. Each of the experiments of the sample films was repeated for three times.

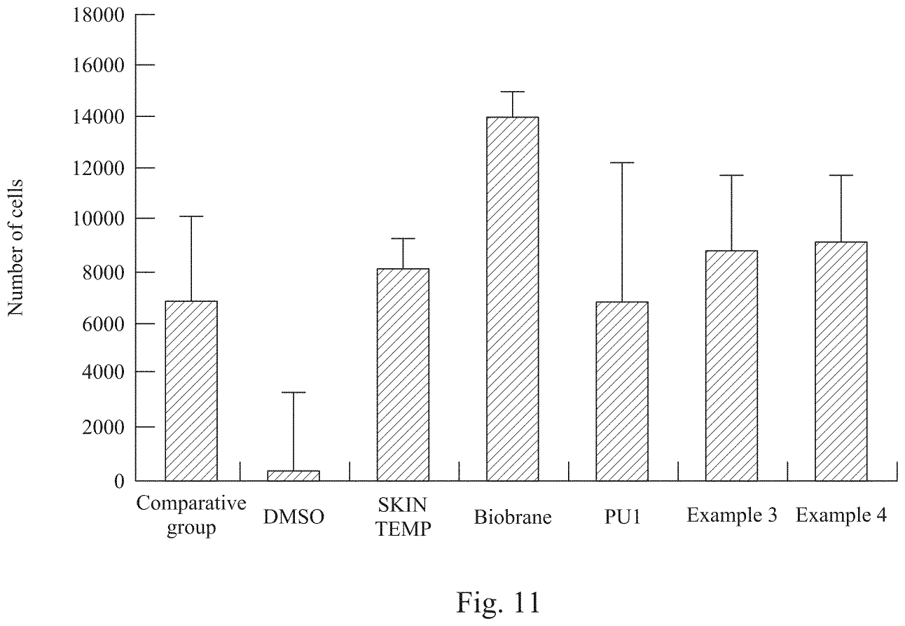

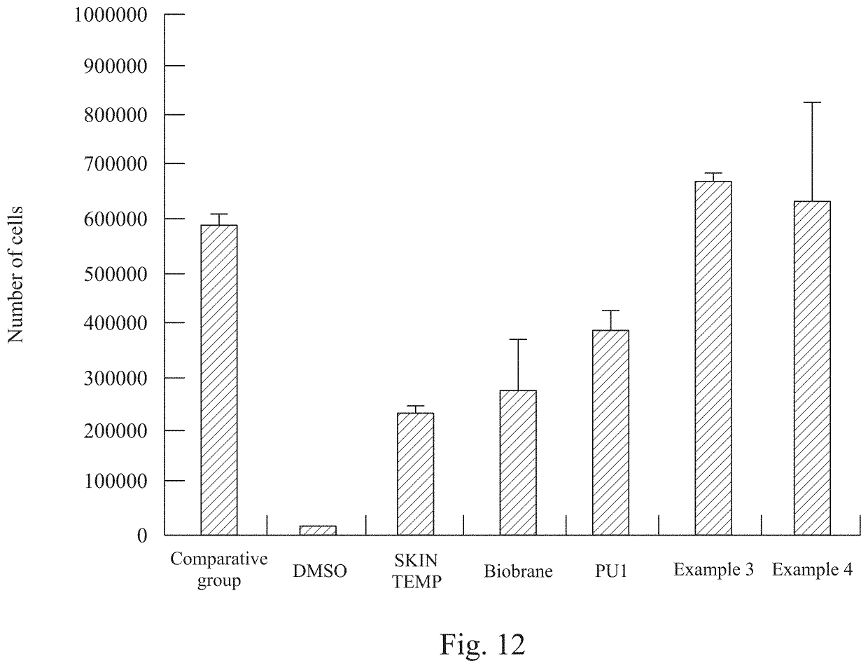

The experiments of the cell adhesion and the cell toxicity were performed by using a MTT method, in which a concentration of 3-(4,5)-dimethylthiahiazo (-z-y1)-2,5-di-phenyltetrazoliumromide (MTT) was 0.5 mg/ml, the reaction time for the cell adhesion experiment was 4 hours, and the reaction time for the cell cytotoxicity was 6 hours. Then, dimethyl sulfoxide was added under 37° C. respectively for 5 minutes (cell adhesion) and 6 hours (cell cytotoxicity) to dissolve crystallites. The result of the cell adhesion experiment is shown as FIG. 11, and the result of the cell cytotoxicity experiment is shown as FIG. 12. In the cell adhesion experiment, an estimated number of the cell lines is positively correlated to a bio-compatibility of the sample film that is used as an environment for the cell culture.

Please refer to Table 1 first. According to the result of the contact angle, the two polymer substrates used in the present invention are respectively hydrophobic (PU1) and hydrophilic (PU2). Furthermore, according to Table 1, the hydrophilicity of the polymer substrate may be improved after the collagen is grafted to the polymer substrate, whether the polymer substrate is originally hydrophobic or hydrophilic. However, merely slight improvement of the hydrophilicity can be achieved when the plasma treatment is not performed. On the other hand, the hydrophilicity of the composite film is significantly improved after the plasma treatment is performed. In other words, a better efficiency of grafting the collagen to the polymer substrate can be realized by performing the plasma treatment.

In addition, Table 1 also shows that the hydrophilicity of the composite film increases when the time for grafting the collagen to the polymer substrate increases from 1 hour to 12 hours. However, when the time is longer than 12 hours (e.g., 24 hours), the hydrophilicity of the composite film is not further improved.

Next, please refer to FIG. 3A and FIG. 3B. FIG. 3A and FIG. 3B are results of dyeing the sample films of Examples 1 to 4, the sample film of Comparative example 1 and the PU1 film using Comassie blue and Genipin. As shown in FIG. 3A and FIG. 3B, a color of the PU1 film gets darker with the increase of the time for grafting the collagen to the polymer substrate, and this indicates greater amount of the collagen grafted to the polymer substrate. However, the color of Example 4 is similar to the color of Comparative example 1, and this indicates that the reaction of grafting the collagen is almost complete after performed for 12 hours.

Then, please refer to FIG. 4A and FIG. 4B. FIG. 4A and FIG. 4B are results of dyeing the sample films of Examples 5 to 8, the sample film of Comparative example 2 and the PU2 film using Comassie blue and Genipin. As shown in FIG. 4A and FIG. 4B, a color of the PU2 film gets darker with the increase of the time for grafting the collagen to the polymer substrate, and this indicates greater amount of the collagen grafted to the polymer substrate. However, the color of Example 8 is similar to the color of Comparative example 2, and this indicates that the reaction of grafting the collagen is almost complete after performed for 12 hours. On the other hand, FIG. 3A is compared to FIG. 4A, and the amount of the grafted collagen on the hydrophilic polymer substrate (Examples 5 to 8) is greater than the amount of the grafted collagen on the hydrophobic polymer substrate (Examples 1 to 4) after the plasma treatment is performed.

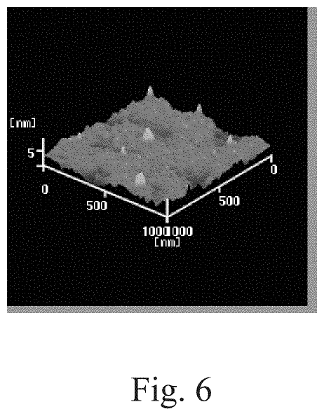

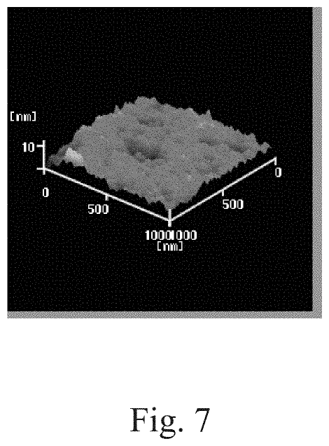

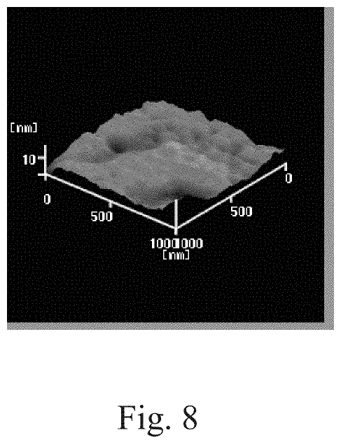

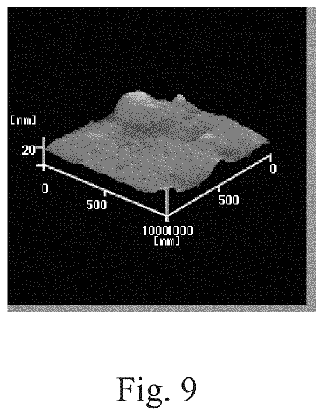

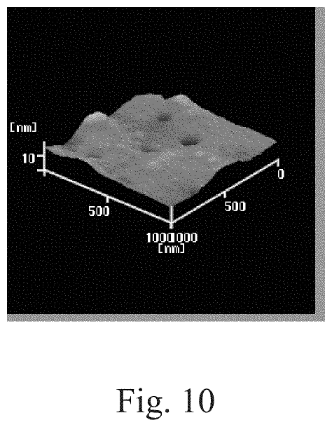

Next, please refer to FIG. 5 through FIG. 10. FIG. 5 through FIG. 10 are three dimensional (3D) diagrams of an AFM. FIG. 5 shows the PU1 film on which the plasma treatment is performed without grafting the collagen thereto. FIG. 6 is the composite film of Example 3. FIG. 7 is the composite film of Example 4. FIG. 8 is the PU2 film on which the plasma treatment is performed without grafting the collagen thereto. FIG. 9 is the composite film of Example 7. FIG. 10 is the composite film of Example 8.

As shown in FIG. 5 through FIG. 7, the surface of the PU1 film becomes coarse after the plasma treatment is performed. However, the surface tends to be flat after the collage is grafted to the surface. The same results are also observable at the PU2 film shown in FIG. 8 through FIG. 10.

Next, please refer to FIG. 11 and FIG. 12. FIG. 11 is a result for the cell adhesion experiment. FIG. 12 is a result of the cell cytotoxicity experiment. Commercial wound dressings, SKIN TEMP (manufactured by Human BioSciences) and Biobrane (manufactured by Smith & Nephew), the PU1 without a treatment and the composite films of Example 3 and 4 are used to implement the experiments of FIG. 11 and FIG. 12. In FIG. 11 and FIG. 12, a comparative group is obtained by detecting the cell lines that the cell culture is implemented in a cell culture dish using the MTT method; and, a DMSO group represents a background value obtained from the culture solution, MTT and DMSO without the cell lines.

As shown in FIG. 11, the commercial wound dressing Biobrane is excellent in cell adhesion. Compared to the PU1 film that is not treated, the composite films on which the plasma treatment and the grafting operation of the collagen are performed in the present invention are also excellent in cell adhesion. The effect of the cell adhesion in the present invention is comparable to the effect of the cell adhesion using the commercial wound dressing.

As shown in FIG. 12, the bio-compatibility of the PU1 film that is note treated is better than the bio-compatibility of the commercial wound dressings SKIN TEMP and Biobrane. Furthermore, the bio-compatibility of the composite film on which the plasma treatment and the grafting operation of the collagen are performed is better than the PU1 film.

In the method of forming the polymer-collagen composite film of the present invention, the plasma treatment using certain process parameters is performed to increase the amount of the grafted collagen on the polymer substrate, thereby improving the hydrophilicity of the polymer-collagen composite film. In addition, the method shortens the process time, and the polymer-collagen composite film has excellent bio-compatibility, such that the composite film can be applied to a wound dressing.

Although the present invention has been described in considerable detail with reference to certain embodiments thereof, while it is not intended to limit the present invention. It will be apparent to those skilled in the art that various modifications and variations can be made to the structure of the present invention without departing from the scope or spirit of the invention. Therefore, the spirit and scope of the appended claims should not be limited to the description of the embodiments contained herein.

What is claimed is:

1. A method of forming a polymer-collagen composite film, the method comprising:
providing a polymer substrate;
performing a plasma treatment on a surface of the polymer substrate, so as to form a treated film, wherein the plasma treatment is performed on different locations of the surface at a moving rate during a treatment time period; and
making collagen in contact with the treated film, thereby forming a polymer-collagen composite film.

2. The method of claim 1, wherein the treatment time period is in a range from 1 second to 10 seconds.

3. The method of claim 1, wherein a power of the plasma treatment is in a range from 400 W to 800 W.

4. The method of claim 1, wherein the moving rate is in a range from 200 mm/sec to 400 mm/sec.

5. The method of claim 1, wherein a height for performing the plasma treatment is in a range from 5 mm to 10 mm.

6. The method of claim 1, wherein a material of the polymer substrate comprises polyurethane, polyethylene, polysiloxane or chitosan.

7. The method of claim 1, wherein the polymer substrate comprises a polymer film or a polymer powder.

8. The method of claim 1, wherein making the collagen in contact with the treated film comprises coating a collagen solution onto a surface of the treated film.

9. The method of claim 1, wherein making the collagen in contact with the treated film comprises forming a bond between the treated film and the collagen.

10. The method of claim 1, wherein making the collagen in contact with the treated film is performed for 1 hour to 12 hours.

11. A polymer-collagen composite film formed by the method of claim 1, wherein the polymer-collagen composite film comprises:
a polymer layer; and
a collagen layer, bonding to a surface of the polymer layer.
